(19) United States
(12) Patent Application Publication
(10) Pub. No.: US 2025/0362508 A1
(43) Pub. Date: Nov. 27, 2025

(54) Waveguide Display with Gaze-to-Wake Gratings

(71) Applicant: Apple Inc., Cupertino, CA (US)

(72) Inventor: Brandon Born, Sunnyvale, CA (US)

(21) Appl. No.: 19/206,902

(22) Filed: May 13, 2025

Related U.S. Application Data
(60) Provisional application No. 63/651,612, filed on May 24, 2024.

(51) Int. Cl. G02B 27/01

(52) U.S. Cl. CPC G02B 27/0172; G02B 2027/0174

(57) ABSTRACT

An electronic device may include a waveguide that directs light to an eye box. The waveguide may include a diffractive grating structure. A projector may generate image light coupled into the waveguide by a first input coupler. A light source may generate supplemental light coupled into the waveguide by a second input coupler. The diffractive grating structure may couple the image light out of the waveguide within a central region of the field of view (FOV) of an eye box and may couple the supplemental light out of the waveguide at a location within a peripheral region of the FOV. The location may be outside of the central region by at least 10 degrees. A gaze tracking sensor may estimate a user's gaze direction at the eye box. A processor may wake or power down the projector responsive to the gaze direction overlapping the location for a predetermined time period.

This application claims the benefit of U.S. Provisional Patent Application No. 63/651,612, filed May 24, 2024, which is hereby incorporated by reference herein in its entirety.

### FIELD

This disclosure relates to optical systems, including optical systems in electronic devices having displays.

### BACKGROUND

Electronic devices can include displays that provide images near the eyes of a user. Such electronic devices often include virtual or augmented reality headsets with displays having optical elements that allow users to view the displays. If care is not taken, components used to display images can be bulky, might not exhibit desired levels of optical performance, or can consume excessive power.

### SUMMARY

An aspect of the disclosure provides an electronic device. The electronic device can include a projector configured to output first light containing images. The electronic device can include a light source configured to output second light at a visible wavelength. The electronic device can include a waveguide configured to propagate the first and second light. The electronic device can include a diffractive grating structure on the waveguide, the diffractive grating structure being configured to diffract the first light out of the waveguide within a first region of a field of view (FOV), and diffract the second light out of the waveguide within a second region of the FOV that surrounds the first region.

An aspect of the disclosure provides an electronic device configured to display images at an eye box having a field of view (FOV). The electronic device can include a projector configured to generate first light containing the images. The electronic device can include a light source configured to generate second light at a visible wavelength. The electronic device can include a waveguide. The electronic device can include a first input coupler configured to couple the first light into the waveguide. The electronic device can include a second input coupler configured to couple the second light into the waveguide. The electronic device can include a diffractive grating structure configured to couple the first and second light out of the waveguide, the first light being confined to a central region of the FOV and the second light being confined to a location within the FOV that is at least 10 degrees outside of the central region.

An aspect of the disclosure provides a method of operating an electronic device. The method can include coupling, using a first input coupler, first light containing images into a waveguide. The method can include coupling, using a second input coupler, second light at a visible wavelength into the waveguide. The method can include coupling, using a diffractive grating structure, the first light out of the waveguide and confined to a region of a field of view (FOV) of an eye box. The method can include coupling, using the diffractive grating structure, the second light out of the waveguide at a location within the FOV that outside the region of the FOV and that is separated from an edge of the region of the FOV by at least 10 degrees.

### BRIEF DESCRIPTION OF THE DRAWINGS

FIG. 1 is a diagram of an illustrative system having a display in accordance with some embodiments.

FIG. 2 is a top view of an illustrative optical system for a display having a waveguide that directs image light and supplemental light to an eye box in accordance with some embodiments.

FIGS. 3A-3C are top views of illustrative waveguides provided with a surface relief grating in accordance with some embodiments.

FIG. 4 is a cross-sectional top view of an illustrative optical coupler that includes a set of holograms in accordance with some embodiments.

FIG. 5 is a front view of an illustrative waveguide having a cross-coupler and an output coupler that direct image light and supplemental light to an eye box in accordance with some embodiments.

FIG. 6 is a front view of an illustrative waveguide having an interleaved coupler that directs image light and supplemental light to an eye box in accordance with some embodiments.

FIG. 7 shows the field of view of an illustrative eye box provided with image light and supplemental light in accordance with some embodiments.

FIG. 8 is a flow chart of illustrative gaze-to-wake operations that may be performed by a display of the type shown in FIGS. 1-8 in accordance with some embodiments.

### DETAILED DESCRIPTION

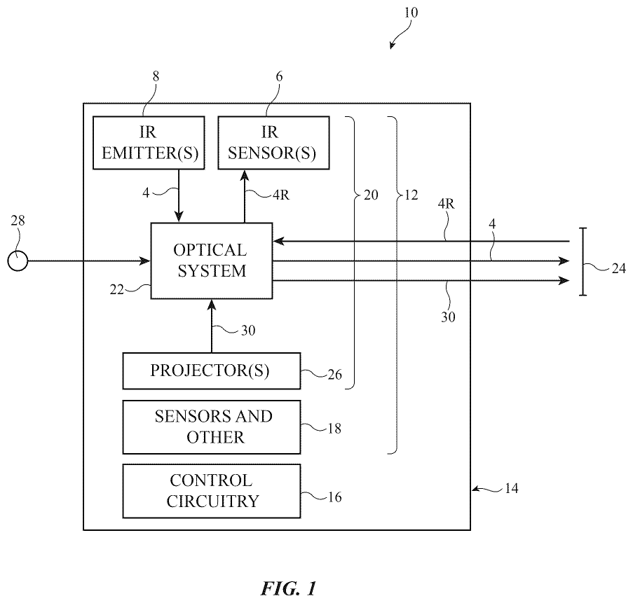

System 10 of FIG. 1 may be an electronic device such as a head-mounted device having one or more displays. The displays in system 10 may include near-eye displays 20 mounted within support structure (housing) 14. Support structure 14 may have the shape of a pair of eyeglasses or goggles (e.g., supporting frames), may form a housing having a helmet shape, or may have other configurations to help in mounting and securing the components of near-eye displays 20 on the head or near the eye of a user. Near-eye displays 20 may include one or more display projectors such as projectors 26 (sometimes referred to herein as display modules 26) and one or more optical systems such as optical systems 22. Projectors 26 may be mounted in a support structure such as support structure 14. Each projector 26 may emit image light 30 that is redirected towards a user's eyes at eye box 24 using an associated one of optical systems 22. Image light 30 may be, for example, visible light (e.g., including wavelengths from 400-700 nm) that contains and/or represents something viewable such as a scene or object (e.g., virtual objects as modulated onto the image light using the image data provided by the control circuitry to the display module).

The operation of system 10 may be controlled using control circuitry 16. Control circuitry 16 may include storage and processing circuitry for controlling the operation of system 10. Control circuitry 16 may include storage such as hard disk drive storage, nonvolatile memory (e.g., electrically-programmable-read-only memory configured to form a solid state drive), volatile memory (e.g., static or dynamic random-access-memory), etc. Processing circuitry in control circuitry 16 may include one or more processors (e.g., microprocessors, microcontrollers, digital signal processors, baseband processors, etc.), power management units, audio chips, graphics processing units, application specific integrated circuits, and other integrated circuits. Software code may be stored on storage in control circuitry 16 and run on processing circuitry in control circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted device 10 with user input. Input-output devices 12 may also be used to gather information on the environment in which system 10 (e.g., head-mounted device 10) is operating. Output components in devices 12 may allow system 10 to provide a user with output and may be used to communicate with external electrical equipment. Input-output devices 12 may include sensors and other components 18 (e.g., image sensors for gathering images of real-world object that are digitally merged with virtual objects on a display in system 10, accelerometers, depth sensors, light sensors, haptic output devices, speakers, batteries, wireless communications circuits for communicating between system 10 and external electronic equipment, etc.).

Projectors 26 may include liquid crystal displays, organic light-emitting diode displays, laser-based displays, or displays of other types. Projectors 26 may include light sources, emissive display panels, transmissive display panels that are illuminated with illumination light from light sources to produce image light, reflective display panels such as digital micromirror display (DMD) panels and/or liquid crystal on silicon (LCOS) display panels that are illuminated with illumination light from light sources to produce image light 30, etc.

Optical systems 22 may form lenses that allow a viewer (see, e.g., a user's eyes at eye box 24) to view images on display(s) 20. There may be two optical systems 22 (e.g., for forming left and right lenses) associated with respective left and right eyes of the user. A single display 20 may produce images for both eyes or a pair of displays 20 may be used to display images. In configurations with multiple displays (e.g., left and right eye displays), the focal length and positions of the lenses formed by system 22 may be selected so that any gap present between the displays will not be visible to a user (e.g., so that the images of the left and right displays overlap or merge seamlessly).

If desired, optical system 22 may contain components (e.g., an optical combiner, etc.) to allow real-world light (sometimes referred to as world light) from real-world (external) objects such as object 28 to be combined optically with virtual (computer-generated) images such as virtual images in image light 30. In this type of system, which is sometimes referred to as an augmented reality system, a user of system 10 may view both real-world content (e.g., world light from object 28) and computer-generated content that is overlaid on top of the real-world content. Camera-based augmented reality systems may also be used in device 10 (e.g., in an arrangement in which a camera captures real-world images of object 28 and this content is digitally merged with virtual content at optical system 22).

System 10 may, if desired, include wireless circuitry and/or other circuitry to support communications with a computer or other external equipment (e.g., a computer that supplies display 20 with image content). During operation, control circuitry 16 may supply image content to display 20. The content may be remotely received (e.g., from a computer or other content source coupled to system 10) and/or may be generated by control circuitry 16 (e.g., text, other computer-generated content, etc.). The content that is supplied to display 20 by control circuitry 16 may be viewed by a viewer at eye box 24.

If desired, system 10 may include an optical sensor. The optical sensor may be used to gather optical sensor data associated with a user's eyes at eye box 24. The optical sensor may, for example, be a gaze tracking sensor that gathers optical sensor data such as gaze image data (gaze tracking image data or gaze tracking sensor data) from a user's eye at eye box 24. Control circuitry 16 may process the optical sensor data to identify, detect, estimate, and/or track the direction of the user's gaze in real time. Control circuitry 16 may perform any desired operations based on the tracked direction of the user's gaze over time.

As shown in FIG. 1, the optical sensor (gaze tracking sensor) may include one or more optical emitters such as infrared emitter(s) 8 and one or more optical receivers (sensors) such as infrared sensor(s) 6 (sometimes referred to herein as optical sensor 6). Infrared emitter(s) 8 may include one or more light sources that emit sensing light such as light 4. Light 4 may be used for performing optical sensing on/at eye box 24 (e.g., gaze tracking) rather than conveying pixels of image data such as in image light 30. Light 4 may include infrared light. The infrared light may be at infrared (IR) wavelengths and/or near-infrared (NIR) wavelengths (e.g., any desired wavelengths from around 700 nm to around 10 um). Light 4 may additionally or alternatively include wavelengths less than 700 nm if desired. Light 4 may sometimes be referred to herein as sensor light 4.

Infrared emitter(s) 8 may direct light 4 towards optical system 22. Optical system 22 may direct the light 4 emitted by infrared emitter(s) 8 towards eye box 24. Light 4 may enter the user's eye at eye box 24 and may reflect off portions (regions) of the user's eye (e.g., the user's retina, iris, and cornea) as reflected light 4R (sometimes referred to herein as reflected sensor light 4R or a reflected version of light 4). Optical system 22 may receive reflected light 4R and may direct reflected light 4R towards infrared sensor(s) 6. Infrared sensor(s) 6 may receive reflected light 4R from optical system 22 and may gather (e.g., generate, measure, sense, produce, etc.) optical sensor data in response to the received reflected light 4R. Infrared sensor(s) 6 may include an image sensor or camera (e.g., an infrared image sensor or camera), for example. Infrared sensor(s) 6 may include, for example, one or more image sensor pixels (e.g., arrays of image sensor pixels). The optical sensor data may include image sensor data (e.g., image data, infrared image data, one or more images, etc.). Infrared sensor(s) 6 may pass the optical sensor data to control circuitry 16 for further processing. The control circuitry may identify, estimate, or detect, based on the optical sensor data, a one, two, or three-dimensional spatial position of the eye within eye box 24 and/or an orientation (gaze direction) of the eye within eye box 24 (e.g., a gaze vector oriented in the direction of the user's gaze).

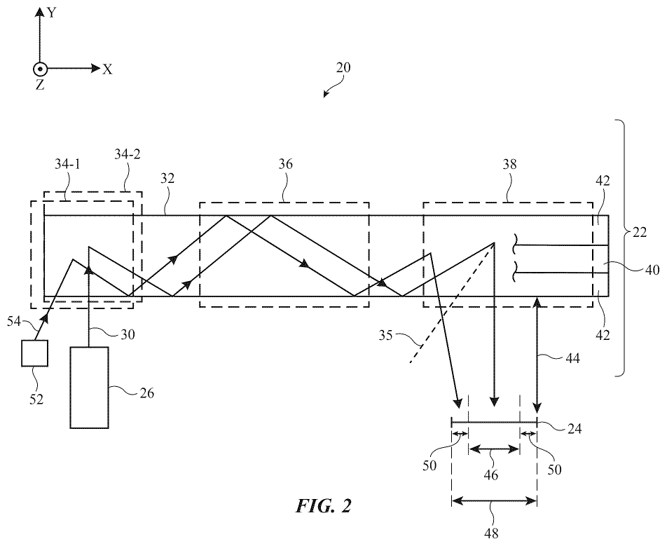

FIG. 2 is a top view of an illustrative display 20 that may be used in system 10 of FIG. 1. As shown in FIG. 2, display 20 may include a projector such as projector 26 and an optical system such as optical system 22. Optical system 22 may include optical elements such as one or more waveguides 32. Waveguide 32 may include one or more stacked substrates 42 (e.g., stacked planar and/or curved layers sometimes referred to herein as waveguide substrates) of optically transparent material such as plastic, polymer, glass, etc.

If desired, waveguide 32 may also include one or more layers of holographic recording media (sometimes referred to herein as holographic media, grating media, or diffraction grating media) on which one or more diffractive gratings are recorded (e.g., holographic phase gratings, sometimes referred to herein as holograms, surface relief gratings, etc.) such as a layer of grating medium 40. Grating medium 40 may be stacked or sandwiched between a pair of waveguide substrates 42 or may be layered onto a single waveguide substrate 42.

A holographic recording may be stored as an optical interference pattern (e.g., alternating regions of different indices of refraction) within a photosensitive (photoactive) optical material such as grating medium 40. The holographic recording may be, for example, a non-switchable diffractive grating that is encoded with a permanent interference pattern. In other implementations, a switchable diffractive grating may be provided in which the diffracted light can be modulated by controlling an electric field applied to the grating medium. Multiple holographic phase gratings (holograms) may be recorded within (e.g., superimposed within) the same volume of grating medium 40 if desired. The holographic phase gratings may be, for example, volume holograms or thin-film holograms in the grating medium. Grating medium 40 may include photopolymers, gelatin such as dichromated gelatin, silver halides, holographic polymer dispersed liquid crystal, or other suitable holographic media.

Diffractive gratings on waveguide 32 may include holographic phase gratings such as volume holograms (sometimes referred to herein as volume phase holograms (VPHs)) or thin-film holograms, meta-gratings, or any other desired diffractive grating structures. The diffractive gratings on waveguide 32 may also include surface relief gratings (SRGs) disposed at, in, or on one or more surfaces of the substrates in waveguide 32 (e.g., as modulations in thickness of a SRG medium layer layered onto a lateral surface of waveguide 32), gratings formed from patterns of metal structures (e.g., nanostructures), etc. The diffractive gratings may, for example, include multiple multiplexed gratings (e.g., holograms) that at least partially overlap within the same volume of grating medium (e.g., for diffracting different colors of light and/or light from a range of different input angles at one or more corresponding output angles). Other light redirecting elements such as louvered mirrors may be used in place of diffractive gratings in waveguide 32 if desired (e.g., within grating medium 40 and/or separate waveguide layers). The diffractive gratings may include meta-materials or metasurfaces if desired.

As shown in FIG. 2, projector 26 may generate (e.g., produce and emit) image light 30 associated with image content to be displayed to eye box 24 (e.g., image light 30 may convey a series of image frames for display at eye box 24). Image light 30 may be collimated using a collimating lens in projector 26 if desired. Optical system 22 may be used to present image light 30 output from projector 26 to eye box 24. If desired, projector 26 may be mounted within support structure 14 of FIG. 1 whereas optical system 22 may be mounted between portions of support structure 14 (e.g., to form a lens that aligns with eye box 24). Other mounting arrangements may be used, if desired.

Optical system 22 may include one or more optical couplers (e.g., light redirecting elements) such as input coupler 34-1, cross-coupler 36, and output coupler 38. In the example of FIG. 2, input coupler 34-1, cross-coupler 36, and output coupler 38 are formed at or on waveguide 32. Input coupler 34-1, cross-coupler 36, and/or output coupler 38 may be completely embedded within the substrate layers of waveguide 32 and/or grating medium 40, may be partially embedded within the substrate layers of waveguide 32 and/or grating medium 40, may be mounted to waveguide 32 (e.g., mounted to an exterior surface of waveguide 32), may be implemented in additional layers on or within waveguide 32, etc.

Waveguide 32 may guide image light 30 down its length via total internal reflection (TIR). Input coupler 34-1 may be configured to couple image light 30 from projector 26 into waveguide 32 (e.g., onto angles within a TIR range of the waveguide, within which light propagates down the waveguide via TIR), whereas output coupler 38 may be configured to couple image light 30 from within waveguide 32 (e.g., propagating within the TIR range) to the exterior of waveguide 32 and towards eye box 24 (e.g., onto angles outside of the TIR range). Input coupler 34-1 may include an input coupling prism, an edge or face of waveguide 32, a lens, a steering mirror or liquid crystal steering element, diffractive grating structures (e.g., volume holograms, SRGs, etc.), partially reflective structures (e.g., louvered mirrors), and/or any other desired input coupling elements.

As an example, projector 26 may emit image light 30 in direction +Y towards optical system 22. When image light 30 strikes input coupler 34-1, input coupler 34-1 may redirect image light 30 so that the light propagates within waveguide 32 via total internal reflection towards output coupler 38 (e.g., in direction +X within the TIR range of waveguide 32). When image light 30 strikes output coupler 38, output coupler 38 may redirect image light 30 out of waveguide 32 towards eye box 24 (e.g., back along the Y-axis).

In implementations where cross-coupler 36 is formed on waveguide 32, cross-coupler 36 may redirect image light 30 in one or more directions as it propagates down the length of waveguide 32 (e.g., towards output coupler 38 from a direction of propagation as coupled into the waveguide by the input coupler). This may, for example, help to direct light from input coupler 34-1 towards output coupler 38 regardless of the lateral locations of input coupler 34-1 and output coupler 38 on display 20. When redirecting image light 30, cross-coupler 36 may also perform pupil (image) expansion on image light 30 in one or more directions. In expanding pupils of the image light, cross-coupler 36 may, for example, help to reduce the vertical size of waveguide 32 (e.g., in the Z direction) relative to implementations where cross-coupler 36 is omitted. Cross-coupler 36 may therefore sometimes also be referred to herein as pupil expander 36 or optical expander 36. If desired, output coupler 38 may also expand image light 30 upon coupling the image light out of waveguide 32 (e.g., in a direction orthogonal to the direction of expansion performed by cross-coupler 36).

Input coupler 34-1, cross-coupler 36, and/or output coupler 38 may be based on reflective and refractive optics or may be based on diffractive (e.g., holographic) optics. In arrangements where couplers 34-1, 36, and 38 are formed from reflective and refractive optics, couplers 34-1, 36, and 38 may include one or more reflectors (e.g., an array of micromirrors, partial mirrors, louvered mirrors, or other reflectors), prisms, and/or angled waveguide faces. In arrangements where couplers 34-1, 36, and 38 are based on diffractive optics, couplers 34-1, 36, and 38 may include diffractive gratings (e.g., volume holograms, surface relief gratings, etc.).

Volume holograms in waveguide 32 may be disposed within grating medium 40 and/or within additional layers of grating media on or within waveguide 32 (not shown in FIG. 2 for the sake of clarity). Each volume hologram may be recorded within its corresponding grating medium as a respective modulation in the refractive index n of the grating medium (e.g., where planes of constant refractive index in the grating medium form the fringes of the hologram). The volume holograms may be recorded using two interfering recording beams of light (e.g., a signal beam and a reference beam) in a holographic recording (writing) apparatus during the manufacture of system 10. The interference pattern of the beams of light is recorded as a modulation in refractive index n of grating medium 40. Once the interference pattern has been recorded in grating medium 40, the grating medium 40 may be developed (cured) using curing light. Once cured, no further volume holograms can be recorded or written in the grating medium.

Each volume hologram may be defined or characterized by a corresponding grating vector k (e.g., in momentum space or k-space). Grating vector k has a magnitude (grating frequency) that corresponds to the wavelength of light diffracted by that volume hologram (e.g., a wavelength at which light is Bragg-matched to the volume hologram). The grating frequency is also related to the spacing between the lines of constant index. The direction of grating vector k is orthogonal to the lines of constant refractive index in the volume hologram. The direction of grating vector k is also related to the incident angle and the output/diffracted angle with which the volume hologram diffracts light (e.g., the direction of grating vector k determines the incident and output/diffracted angles of the volume hologram that satisfy its Bragg matching condition). In other words, the direction of grating vector k identifies the incident angle of light that is diffracted by the volume hologram as well as the corresponding output (diffracted) angle that the light is diffracted onto. The volume hologram may diffract light from an incident angle onto an output angle but also conversely diffracts light incident from the output angle onto the incident angle.

Multiple volume holograms may be superimposed or multiplexed within the same volume of a corresponding grating medium. Put differently, at a given point within the volume of the grating medium, there may be one or more superimposed volume holograms formed from corresponding refractive index modulations that are superimposed onto each other at that point of the grating medium. As modulated, the refractive index may sometimes be referred to herein as modulated refractive index dn (e.g., a refractive index that varies spatially across the area of the grating medium). The multiplexed volume holograms may have different grating frequencies (grating vector magnitudes) for diffracting a range of different wavelengths of light and/or different orientations (grating vector directions) for diffracting light from a range of incident angles onto a corresponding range of output angles. Additionally or alternatively, the multiplexed volume holograms may, if desired, perform expansion on the diffracted light (e.g., by collectively diffracting light from a single incident angle onto a range of different output angles).

The operation of waveguide 32 on image light 30 is shown in FIG. 2. Waveguide 32 may also be used to direct light 4 from infrared emitter(s) 8 towards eye box 24 and to direct reflected light 4R from eye box 24 towards IR sensor(s) 6 (FIG. 1) (e.g., for performing gaze detection and/or tracking). Input coupler 34-1, cross-coupler 36, and/or output coupler 38 may direct light 4 from IR emitter(s) 8 (FIG. 1) to eye box 24 and/or to direct reflected light 4R from eye box 24 to IR sensor(s) 6 (FIG. 1). Alternatively, waveguide 32 may include one or more additional optical couplers that redirect light 4 and/or reflected light 4R but not image light 30. Alternatively, IR emitter(s) 8 may provide light 4 directly to eye box 24 (e.g., without propagation through waveguide 32) or to eye box 24 via an additional waveguide. Additionally or alternatively, reflected light 4R may pass directly to IR sensor(s) 6 (e.g., without propagation through waveguide 32) or to IR sensor(s) 6 via an additional waveguide. If desired, optical system 22 may additionally or alternatively direct world light towards eye box 24 and/or towards a world-facing camera in system 10.

Holograms used to form input coupler 34, cross-coupler 36, and/or output coupler 38 may include transmission holograms and/or reflection holograms. Transmission holograms are recorded using two recording beams incident from the same side of the grating medium. Diffraction of image light 30 by transmission holograms in waveguide 32 is sometimes also referred to herein as transmission by the holograms (e.g., diffraction onto an output angle less than 90 degrees from the direction of propagation prior to diffraction). Transmission holograms are sometimes also referred to herein as transmissive holograms.

On the other hand, reflection holograms are recorded using two recording beams incident from opposing sides of the grating medium. Diffraction of image light 30 by reflection holograms in waveguide 32 is sometimes also referred to herein as reflection by the holograms (e.g., diffraction onto an output angle greater than or equal to 90 degrees from the direction of propagation prior to diffraction). Reflection holograms are sometimes also referred to herein as reflective holograms.

In some implementations, output coupler 38 may include a set of multiplexed reflection holograms. In an ordinary mirror, the mirror reflects incident light from an incident angle onto a reflected angle such that the normal axis of the mirror (e.g., the Y-axis for a mirror in the X-Z plane of FIG. 2) bisects the incident angle and the reflected angle. Unlike an ordinary mirror, reflective holograms in output coupler 38 diffract light from an incident angle onto an output angle such that the output angle and the incident angle are bisected by a skew axis 35 that is offset, tilted, or skewed from the normal (e.g., perpendicular or orthogonal) axis of the lateral surfaces of waveguide 32 by a non-zero angle. The skew axis may be constant or may vary by less than a threshold amount (e.g., less than one degree, less than two degrees, less than half a degree, etc.) across all of the holograms in the output coupler. When configured in this way, the set of holograms (e.g., multiplexed reflection volume holograms) used to form output coupler 38 is sometimes also referred to herein as a skew mirror or holomirror. The holograms in a holomirror may, for example, have non-constant pitch across the lateral area of the holomirror. This example is illustrative and non-limiting. Alternatively, output coupler 38 may include holograms having constant pitch or may include one or more surface relief gratings.

The example of FIG. 2 is illustrative and non-limiting. Optical system 22 may include multiple waveguides that are laterally and/or vertically stacked with respect to each other. Each waveguide may include one, two, all, or none of couplers 34-1, 36, and 38. Waveguide 32 may be at least partially curved or bent if desired. One or more of couplers 34-1, 36, and 38 may be omitted. If desired, optical system 22 may include a single optical coupler that performs the operations of two or more of input coupler 34-1, cross-coupler 36, and output coupler 38 (sometimes referred to herein as an interleaved coupler, a diamond coupler, or a diamond expander).

Image light 30 is light that is modulated, in projector 26, to include or carry image data (e.g., images of image pixels having corresponding pixel values and representing virtual/computer-generated objects or elements) to be displayed at the eye box. Image light 30 may contain any desired number of wavelength ranges or color channels (e.g., red, green, and blue color channels). Eye box 24 may have a field of view (FOV) 48 located at a nominal distance 44 from the user-facing lateral surface of waveguide 32. FOV 48 is sometimes also referred to herein as eye box FOV 48.

Input coupler 34-1, output coupler 38, and optionally cross-coupler 36 may direct image light 30 to eye box 24 at angles spanning a portion or subset of eye box FOV 48, such as angles within central region 46 of eye box FOV 48. Central region 46 may overlap a central axis of eye box FOV 48 and may be located at and around the center of eye box FOV 48. Virtual objects in the image data modulated onto image light 30 may be displayed at eye box 24 within central region 46 of eye box FOV 48. Central region 46 is sometimes also referred to herein as the image light portion, image portion, or virtual object portion of eye box FOV 48. Central region 46 may span a corresponding range of angles around the central (optical) axis of eye box FOV 48.

Eye box FOV 48 may also have an additional portion or subset such as peripheral region 50. Peripheral region 50 may surround the periphery of central region 46 within eye box FOV 48. Peripheral region 50 may, for example, span a range of angles having abosolute values greater than the absolute values of the range of angles spanned by central region 46, as measured about the central (optical) axis of eye box FOV 48 (e.g., peripheral region 50 may contain the angles from eye box FOV 48 that are not included within central region 46). Virtual objects and the image light 30 provided to eye box 24 by output coupler 38 may, for example, be confined to central region 46 of eye box FOV 48 without being provided to peripheral region 50 of eye box FOV 48 (e.g., peripheral region 50 of eye box FOV 48 may be free from virtual objects and image light 30). Central region 46 of eye box FOV 48 is sometimes also referred to herein as image light region 46, virtual object region 46, primary display region 46, virtual object area 46, low angle region 46, or a central portion 46 of eye box FOV 48. Peripheral region 50 of eye box FOV 48 is sometimes also referred to herein as supplemental light region 50, indicator light region 50, gaze-to-wake region 50, secondary display region 50, non-virtual object area 50, high angle region 50, or a peripheral portion 50 of eye box FOV 48.

In addition to image light 30, waveguide 32 may also convey additional light to eye box 24 such as supplemental light 54. Unlike image light 30, supplemental light 54 is unmodulated (e.g., does not include image data, does not convey image pixels of data, and does not include any virtual objects). Supplemental light 54 may also contain fewer wavelengths or wavelength ranges than image light 30. Display 20 may include a light source 52 that emits, generates, outputs, and/or produces supplemental light 54. Light source 52 may be a laser (e.g., a vertical-cavity surface-emitting laser (VCSEL)) or an LED, as examples. Light source 52 may be external to projector 26.

Supplemental light 54 may contain visible light (e.g., at one or more wavelengths between around 400 nm and around 700 nm). Supplemental light 54 may, for example, span only a single wavelength range (e.g., when light source 52 includes an LED) or may substantially include only a single wavelength (e.g., when light source 52 includes a laser). Light source 52 does not include an array of emissive pixels or a spatial light modulator containing pixels (e.g., light source 52 may include only a single emissive element). As such, supplemental light 54 does not include pixels of image data or any spatially modulated information. This may serve to minimize power and space consumption within display 20.

If desired, optics such as one or more lenses or lens elements (not shown) may help to direct supplemental light 54 from light source 52 to input coupler 34-1. Light source 52 is sometimes also referred to herein as supplemental light source 52, icon light source 52, gaze-to-wake light source 52, gaze-to-wake indication light source 52, peripheral light source 52, peripheral indicator (indication) light source 52, or secondary light source 52. Supplemental light 54 is sometimes also referred to herein as gaze-to-wake light 54, gaze-to-wake icon or indication light 54, secondary light 54, contentless light 54, non-image light 54, indication light 54, peripheral indication light 54, peripheral indicator light 54, or peripheral light 54.

Waveguide 32 may include an additional input coupler such as input coupler 34-2. Input coupler 34-2 may include an input coupling prism (e.g., a reflective or transmissive input coupling prism mounted to a substrate 42), an angled waveguide surface, a lens, and/or a diffractive grating structure (e.g., a surface relief grating or a set of holograms). Input coupler 34-2 may be non-overlapping with respect to input coupler 34-1 or may at least partially overlap input coupler 34-1.

Input coupler 34-2 may receive supplemental light 54 from light source 52. Input coupler 34-2 may couple supplemental light 54 into waveguide 32 (e.g., within the TIR range of waveguide 32). Waveguide 32 may propagate supplemental light 54 towards output coupler 38 via TIR. In implementations where waveguide 32 includes cross-coupler 36, cross-coupler 36 may redirect supplemental light 54 towards output coupler 38. Output coupler 38 may couple supplemental light 54 out of waveguide 32 in addition to coupling image light 30 out of waveguide 32. However, unlike image light 30, which output coupler 38 couples out of waveguide 32 at angles such that image light 30 is incident upon eye box 24 within central region 46 of eye box FOV 48, output coupler 38 couples supplemental light 54 out of waveguide 32 at angles such that supplemental light 54 is incident upon eye box 24 at or within only a small portion of the peripheral region 50 of eye box FOV 48 (e.g., supplemental light 54 is confined to peripheral region 50 and is not provided within central region 46).

The supplemental light 54 redirected by output coupler 38 may, for example, be incident upon peripheral region 50 of eye box FOV 48 as a small shape, icon, effective point source, or graphical indication spanning only a very small portion or subset of peripheral region 50 (e.g., where the shape of the supplemental light as visible at eye box 24 is substantially determined by how light source 52 outputs supplemental light 54 to input coupler 34-1). Supplemental light 54 may, for example, appear within peripheral region 50 of eye box FOV 48 as if light source 52 were present within output coupler 38. However, since light source 52 does not physically overlap output coupler 38, world light is transmitted to the eye box through output coupler 38 without being blocked by light source 52.

Supplemental light 54 (e.g., the shape, icon, effective point source, or indication produced by supplemental light 54 within peripheral region 50 of eye box FOV 48) may be used to perform any desired functions for the display. As one example, supplemental light 54 may form a low-resolution visual alert or notification to a user whose eye is present at eye box 24. In other illustrative implementations that are described herein as an example, supplemental light 54 may form a gaze-to-wake indicator for display 20. The gaze-to-wake indicator may serve as a viewing point for the user's gaze that is outside of central region 46 of eye box FOV 48. The gaze tracking sensor on display 20 may detect when the user is gazing or looking at supplemental light 54 (rather than image light 30 or central region 46 of eye box FOV 48) and such a detection may serve as a user input to display 20. The user input may, for example, form a user input to wake projector 26 (e.g., triggering projector 26 to begin outputting image light 30) and/or a user input to turn off projector 26 (e.g., triggering projector 26 to stop outputting image light 30). This may allow projector 26 to be turned on or off as needed, which minimizes power consumption and maximizes battery life for display 20, without requiring the user to remove display 20 from their head or to use their hands or other input devices to instruct display 20 to begin or stop displaying image light 30.

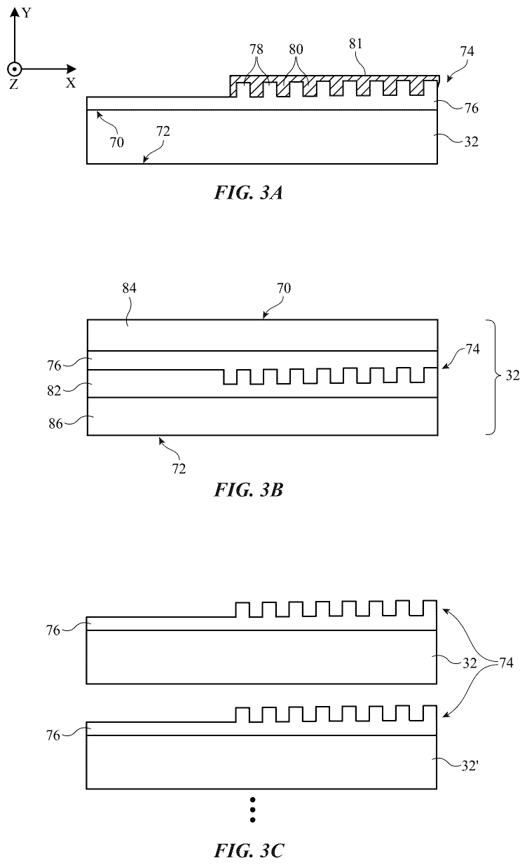

In some implementations that are described herein as an example input coupler 34-1, input coupler 34-2, cross-coupler 36, and/or output coupler 38 include one or more surface relief gratings. FIG. 3A is a top view showing one example of how a surface relief grating may be formed on waveguide 32. As shown in FIG. 3A, waveguide 32 may have a first lateral surface 70 (e.g., lateral surface 39 of FIG. 2) and a second lateral surface 72 (e.g., lateral surface 37 of FIG. 2) opposite lateral surface 70. Waveguide 32 may include any desired number of one or more stacked waveguide substrates (e.g., substrates 42 of FIG. 2). If desired, waveguide 32 may also include a layer of grating medium sandwiched (interposed) between first and second waveguide substrates (e.g., grating medium 40 of FIG. 2 and/or additional layers of grating media).

Waveguide 32 may be provided with a surface relief grating (SRG) such as SRG 74. SRG 74 may be included in input coupler 34-1, input coupler 34-2, cross-coupler 36, output coupler 38 (FIG. 2), or as part of an optical coupler that performs the operations of both cross-coupler 36 and output coupler 38 (e.g., a diamond expander, diamond coupler, or interleaved coupler). SRG 74 may be formed within a substrate such as a layer of SRG substrate 76 (sometimes referred to herein as medium 76, medium layer 76, SRG medium 76, or SRG medium layer 76). While only a single SRG 74 is shown in SRG substrate 76 in FIG. 3A for the sake of clarity, SRG substrate 76 may include two or more SRGs 74 (e.g., SRGs having different respective grating vectors). If desired, at least a portion of each of the SRGs may be superimposed in the same volume of SRG substrate 76. In the example of FIG. 3A, SRG substrate 76 is layered onto lateral surface 70 of waveguide 32. This is merely illustrative and, if desired, SRG substrate 76 may be layered onto lateral surface 72 (e.g., the surface of waveguide 32 that faces the eye box).

SRG 74 may include peaks 78 and troughs 80 in the thickness of SRG substrate 76. Peaks 78 may sometimes also be referred to herein as ridges 78 or maxima 78. Troughs 80 may sometimes also be referred to herein as notches 80, slots 80, grooves 80, or minima 80. In the example of FIG. 3A, SRG 74 is illustrated for the sake of clarity as a binary structure in which SRG 74 is defined either by a first thickness associated with ridges 78 or a second thickness associated with troughs 80. This is illustrative and non-limiting. If desired, SRG 74 may be non-binary (e.g., may include any desired number of thicknesses following any desired profile, may include ridges 78 that are angled at non-parallel fringe angles with respect to the Y axis, etc.), may include ridges 78 with surfaces that are tilted (e.g., oriented outside of the X-Z plane), may include troughs 80 that are tilted (e.g., oriented outside of the X-Z plane), may include ridges 78 and/or troughs 80 that have heights and/or depths that follow a modulation envelope, may be an angled or blazed grating, etc. If desired, SRG substrate 76 may be adhered to lateral surface 70 of waveguide 32 using a layer of optically clear adhesive (not shown). If desired, a thin dielectric, metallic, and/or reflective coating 81 may be layered over SRG 74. Coating 81 may be layered over ridges 78 and troughs 80 (e.g., may fill troughs 80) or may be layered only over ridges 78 without filling troughs 80. If desired, a planarization, homogenization, or encapsulation layer (not shown) may be layered over SRG 74 and coating 81 and/or may fill troughs 80. SRG 74 may be fabricated separately from waveguide 32 and may be adhered to waveguide 32 after fabrication or may be etched into SRG substrate 76 after SRG substrate 76 has already been layered on waveguide 32, for example. If desired, SRG 74 may be cut into waveguide 32 (e.g., substrate 42 or grating medium 40 of FIG. 2) itself rather than in a separate SRG substrate 76 (e.g., substrate 42 or grating medium 40 of FIG. 2 may form the SRG substrate 76 for SRG 74).

The example of FIG. 3A is illustrative and non-limiting. In another implementation, SRG 74 may be placed at a location within the interior of waveguide 32, as shown in the example of FIG. 3B. As shown in FIG. 3B, waveguide 32 may include a first waveguide substrate 84, a second waveguide substrate 86, and a media layer 82 interposed between waveguide substrate 84 and waveguide substrate 86. Media layer 82 may be a grating or holographic recording medium, a layer of adhesive, a polymer layer, a layer of waveguide substrate, or any other desired layer within waveguide 32. SRG substrate 76 may be layered onto the surface of waveguide substrate 84 that faces waveguide substrate 86. Alternatively, SRG substrate 76 may be layered onto the surface of waveguide substrate 86 that faces waveguide substrate 84.

If desired, multiple SRGs 74 may be distributed across multiple layers of SRG substrate, as shown in the example of FIG. 3C. As shown in FIG. 3C, the optical system may include multiple stacked waveguides such as at least a first waveguide 32 and a second waveguide 32′. A first SRG substrate 76 may be layered onto one of the lateral surfaces of waveguide 32 whereas a second SRG substrate 76′ is layered onto one of the lateral surfaces of waveguide 32′. First SRG substrate 76 may include one or more of the SRGs 74. Second SRG substrate 76′ may include one or more of the SRGs 74. This example is illustrative and non-limiting. If desired, the optical system may include more than two stacked waveguides. In examples where the optical system includes more than two waveguides, each waveguide that is provided with an SRG substrate may include one or more SRG 74. While described herein as separate waveguides, waveguides 32 and 32′ of FIG. 3C may also be formed from respective waveguide substrates of the same waveguide, if desired. The arrangements in FIGS. 3A, 3B, and/or 3C may be combined. If desired, waveguide 32 may include first and second SRGs located at opposing lateral surfaces of the waveguide (e.g., waveguide 32 may include a first set of one or more SRGs 74 formed in a first SRG substrate 76 layered onto lateral surface 70 of FIG. 3A or cut into lateral surface 70 itself and may include a second set of one or more SRGs 74 formed in a second SRG substrate 76 layered onto lateral surface 72 of FIG. 3A or cut into lateral surface 72 itself and overlapping the first set of one or more SRGs).

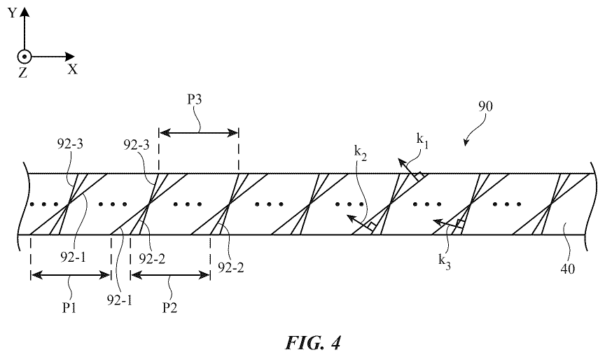

In some implementaitons that are described herein as an example, input coupler 34-1, input coupler 34-2, cross-coupler 36, and/or output coupler 38 (FIG. 2) may include holograms. FIG. 4 is a cross-sectional top view of an optical coupler 90 on waveguide 32 (e.g., input coupler 34-1, input coupler 34-2, cross-coupler 36, output coupler 38, or an interleaved/diamond coupler on waveguide 32) that includes holograms.

As shown in FIG. 4, optical coupler 90 may include a set of one or more holograms 92 (e.g., transmission or reflection volume holograms) recorded in grating medium 40. Holograms 92 are illustrated in FIG. 4 as planes of constant refractive index extending from one lateral surface to the opposing lateral surface across the entire thickness of grating medium 40. In the example of FIG. 4, optical coupler 90 is illustrated as including three holograms 92 for the sake of simplicity (e.g., a first hologram 92-1, a second hologram 92-2, and a third hologram 92-3). This is illustrative and, in general, optical coupler 90 may include a single hologram 92, two holograms 92, or more than three holograms 92 (e.g., more than ten holograms 92, more than 20 holograms 92, more than 50 holograms 92, more than 100 holograms 92, more than 200 holograms 92, more than 300 holograms 92, more than 400 holograms 92, more than 500 holograms 92, fewer than 10 holograms 92, five or fewer holograms 92, etc.).

The pitch P of a hologram 92 is defined as the distance between adjacent planes of the same constant refractive index in the hologram, as measured where the planes meet the lateral surface of grating medium 40. For example, as shown in FIG. 4, hologram 92-1 may have pitch P1, hologram 92-2 may have pitch P2, and hologram 92-3 may have pitch P3. If desired, each hologram 92 in optical coupler 90 may be a constant pitch hologram. As such, pitch P1 of hologram 92-1 may be constant across the lateral area of optical coupler 90, pitch P2 of hologram 92-2 may be constant across the lateral area of optical coupler 90, and pitch P3 of hologram 92-3 may be constant across the lateral area of optical coupler 90. Pitch P1 may be equal to pitches P2 and P3, for example.

Each hologram 92 in optical coupler 90 may be characterized or defined by a corresponding grating vector k. For example, hologram 92-1 may have a first grating vector k₁, hologram 92-2 may have a second grating vector k₂, and hologram 92-3 may have a third grating vector k₃. If desired, grating vectors k₁, k₂, and k₃ may be oriented in slightly different spatial directions. The magnitude of grating vectors k₁, k₂, and k₃ correspond to the wavelength of light diffracted by the associated hologram. Each of holograms 92-1, 92-2, and 92-3 may diffract image light 30 from a different respective incident angle (or range of incident angles) and/or wavelength (or range of wavelengths). In general, the thinner grating medium 40 is, the wider the selectivity and the wider the range of incident angles and wavelengths diffracted by each hologram 92. In examples where grating medium 40 is relatively thick (e.g., thicker than 400 microns, thicker than 500 microns, thicker than 600 microns, etc.), the selectivity of holograms 92 is relatively narrow. As such, optical coupler 90 may include a relatively large number of holograms 92 to collectively capture (diffract) as much of the angular range and wavelength range of image light 30 as possible. Providing holograms 92 with constant pitch in optical coupler 90 may help to optimize image uniformity and efficiency, for example. While some implementations are described herein in which optical coupler 90 includes constant pitch holograms 92, optical coupler 90 may additionally or alternatively include holograms 92 that do not have constant pitch.

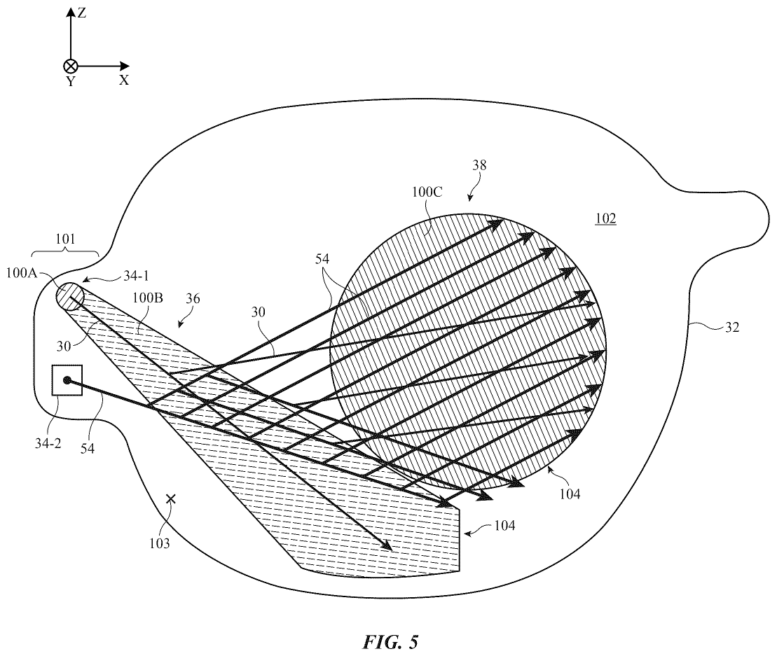

FIG. 5 is a front view of waveguide 32 showing how waveguide 32 may direct both image light 30 and supplemental light 54 to eye box 24 (FIG. 2) in an example where waveguide 32 includes cross-coupler 36 and output coupler 38. As shown in FIG. 5, input coupler 34-1 and input coupler 34-2 may be disposed at two different locations on waveguide 32 (e.g., input coupler 34-1 may span or overlap a first region of waveguide 32 whereas input coupler 34-2 spans or overlaps a second region of waveguide 32 that is laterally offset from the first region). Input couplers 34-1 and 34-2 may, for example, both be disposed at or on an extension 101 of waveguide 32. Extension 101 may, for example, overlap a temple portion or a nose bridge portion of the housing for system 10 (FIG. 1). Light source 52 (FIG. 2) may be mounted in the temple or nose bridge portion of the housing (e.g., near or adjacent to the projector) or may be mounted to waveguide 32 itself (e.g., at or adjacent to extension 101 or elsewhere around the periphery of waveguide 32).

Cross-coupler 36 may be laterally offset from output coupler 38 on waveguide 32. Cross-coupler 36 may also be laterally offset from input coupler 34-1 and/or input coupler 34-2. Cross-coupler 36, input coupler 34-1, and output coupler 38 may have other relative positions, orientations, and/or shapes (e.g., having any desired number of straight and/or curved lateral edges 104 that separate the couplers from non-diffractive region 102 of waveguide 32). Input coupler 34-1 may include a first diffractive grating structure 100A (e.g., a first set of holograms 92 (FIG. 4) or one or more SRGs 74 (FIGS. 3A-3C)). Cross-coupler 36 may include a second diffractive grating structure 100B (e.g., a second set of holograms 92 (FIG. 4) or one or more SRGs 74 (FIGS. 3A-3C)). Output coupler 38 may include a third diffractive grating structure 100C (e.g., a third set of holograms 92 (FIG. 4) or one or more SRGs 74 (FIGS. 3A-3C)). Input coupler 34-2 may include a fourth diffractive grating structure (e.g., a fourth set of holograms 92 (FIG. 4) or one or more SRGs 74) or may include an input coupling prism. If desired, diffractive grating structure 100A may be replaced with an input coupling prism.

In some implementations, for example, diffractive grating structure 100A may include a first SRG 74 in a first region of a given layer of SRG substrate 76 (FIGS. 3A-3C), diffractive grating structure 100B may include a second SRG 74 in a second region of the same layer of SRG substrate 76 (FIGS. 3A-3C), and diffractive grating structure 100C may include a third SRG 74 in a third region of the same layer of SRG substrate 76 (FIGS. 3A-3C). Input coupler 34-2 may include a fourth SRG 74 in a fourth region of the same layer of SRG substrate 76, a fourth SRG 74 in an additional layer of SRG substrate, a set of holograms 92 in a grating medium 40 (FIG. 4) overlapping the layer of SRG substrate 76, or an input coupling prism mounted to waveguide 32. Alternatively, two or more of the SRGs used to form diffractive grating structures 100A, 100B, and 100C may be disposed in two or more different layers of SRG substrate. If desired, one or more of diffractive grating structures 100A, 100B, or 100C may be formed from a respective set of holograms 92 in one or more layers of grating medium 40 overlapping the one or more layers of SRG substrate (e.g., in a hybrid waveguide implementation where one or more of the couplers includes one or more SRGs and one or more of the couplers includes a set of holograms).

In other implementations, for example, diffractive grating structure 100A may include a first set of holograms 92 confined to a first region of a layer of grating medium 40 (FIG. 4), diffractive grating structure 100B may include a second set of holograms 92 confined to a second region of the same layer of grating medium 40 or a different layer of grating medium 40, and diffractive grating structure 100C may include a third set of holograms 92 in a third region of the same layer of grating medium 40 or a different layer of grating medium 40. Input coupler 34-2 may include a fourth set of holograms 92 in a fourth region of the same layer of grating medium 40 or a different layer of grating medium 40. Alternatively, input coupler 34-2 may include an SRG 74 in an SRG substrate layered onto the layer(s) of grating medum 40 or an input coupling prism mounted to waveguide 32. In general, any desired combination of hologram sets, SRGs, and prisms may be used to implement input coupler 34-1, input coupler 34-2, cross-coupler 36, and output coupler 38.

When diffractive grating structures 100A, 100B, and/or 100C include holograms 92, diffractive grating structures 100A, 100B, and/or 100C may each include multiple holograms that are multiplexed or superimposed within the same volume of grating medium 40 (e.g., at each point across the lateral area spanned by the corresponding coupler). Each of the multiplexed holograms 92 in the coupler may, for example, diffract a different respective incident angle (or range of incident angles) and/or wavelength (or range of wavelengths) of image light 30 onto a corresponding output angle (or range of output angles). Put differently, each of the multiplexed holograms 92 may be Bragg-matched to a different incident angle and/or wavelength, or may equivalently be characterized by a different respective selectivity curve having peak diffraction efficiency at a different respective combination of incident angle and wavelength. This may allow the holograms to collectively diffract as much of the incident image light as possible across the color channels output by the projector.

As shown in FIG. 5, diffractive grating structure 100A may couple image light 30 into waveguide 32 and may direct image light 30 towards cross-coupler 36. Diffractive grating structure 100B may redirect image light 30 towards output coupler 38. If desired, diffractive grating structure 100B may also perform pupil replication and/or expansion on image light 30. If desired, diffractive grating structure 100B may perform two diffractions of image light 30 (not shown in FIG. 5 for the sake of clarity) to help mitigate dispersion. Output coupler 38 may redirect image light 30 out of waveguide 32 and towards eye box 24 within central region 46 of eye box FOV 48 (FIG. 2). If desired, output coupler 38 may also expand image light 30. If desired, diffractive grating structure 100C may mitigate dispersion introduced to iamge light 30 by diffractive grating structure 100A.

At the same time, input coupler 34-2 may couple supplemental light 54 into waveguide 32 and may direct supplemental light 54 towards cross-coupler 36. In addition to diffracting image light 30, diffractive grating structure 100B may also diffract supplemental light 54 towards output coupler 38 (e.g., the same SRG(s) or the same set of holograms 92 in diffractive grating structure 100B may be Bragg-matched to and/or may redirect both image light 30 and supplemental light 54). When diffractive grating structure 100B includes a set of holograms 92, the set of holograms may, if desired, include additional holograms that are Bragg-matched to the wavelength(s) of supplemental light 54 and/or that redirect supplemental light 54 incident from the direction of input coupler 34-2 onto output angles oriented towards output coupler 38. When diffractive grating structure 100B includes SRG(s) 74, the SRG(s) 74 may exhibit sufficiently wide selectivity to diffract both image light 30 from input coupler 34-1 and supplemental light 54 from input coupler 34-2 towards output coupler 38.

In addition to diffracting image light 30, diffractive grating structure 100C may also diffract supplemental light 54 out of waveguide 32 and towards the eye box (e.g., the same SRG(s) or the same set of holograms 92 in diffractive grating structure 100C may be Bragg-matched to and/or may redirect both image light 30 and supplemental light 54). When diffractive grating structure 100C includes a set of holograms 92, the set of holograms may, if desired, include additional holograms that are Bragg-matched to the wavelength(s) of supplemental light 54 and/or that redirect supplemental light 54 incident from the direction of cross-coupler 36 onto output angles oriented towards peripheral region 50 of eye box FOV 48 (FIG. 2). When diffractive grating structure 100C includes SRG(s) 74, the SRG(s) 74 may exhibit sufficiently wide selectivity to diffract both image light 30 and supplemental light 54 from cross-coupler 38 towards respective regions of eye box FOV 48.

The placement of input coupler 34-2, the angle with which input coupler 34-2 couples supplemental light 54 into waveguide 32, the configuration of diffractive grating structure 100B, and/or the configuration of diffractive grating structure 100C may be selected to direct the supplemental light 54 coupled out of waveguide 32 by output coupler 38 to eye box 24 only within a portion of the peripheral region 50 of eye box FOV 48 (FIG. 2), thereby forming a visual indication for the user (e.g., for performing a gaze-to-wake operation). Input coupler 34-2 need not be located on extension 101 of waveguide 32 and may, if desired, be located elsewhere such as at location 103.

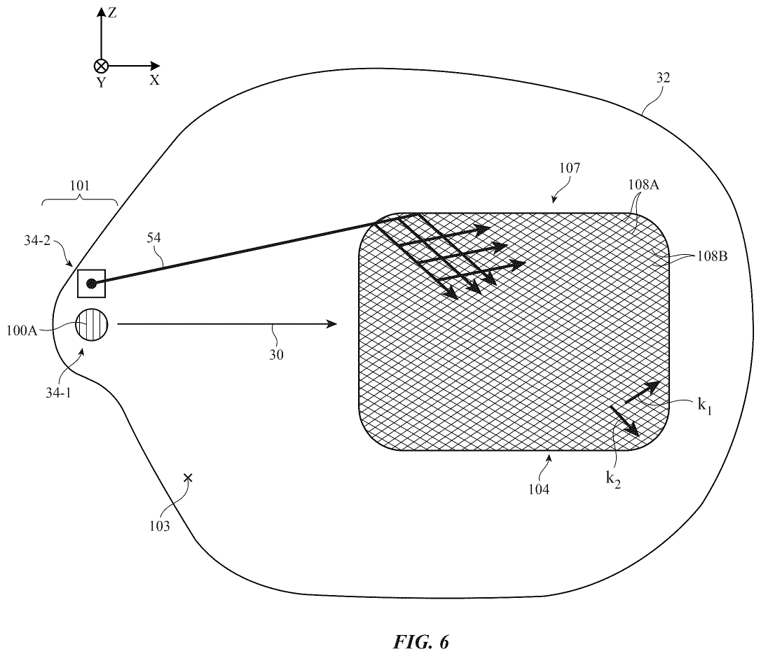

The example of FIG. 5 in which waveguide 32 includes cross-coupler 36 and output coupler 38 is illustrative and non-limiting. If desired, waveguide 32 may include an interleaved optical coupler. FIG. 6 is a front view of waveguide 32 in an implementation where waveguide 32 includes an interleaved optical coupler.

As shown in FIG. 6, waveguide 32 may include an interleaved optical coupler such as interleaved coupler 107 (sometimes also referred to herein as diamond coupler 107 or diamond expander 107). Interleaved coupler 107 may include diffractive grating structures 108A and 108B. Diffractive grating structures 108A and 108B may include respective first and second sets of holograms 92 (FIG. 4) in the same layer of grating medium 40 or in different respective layers of grating medium 40 (e.g., on opposing lateral surfaces of the waveguide). Alternatively, diffractive grating structures 108A and 108B may include respective first and second SRGs 74 in the same layer of SRG substrate 76 or in two different layers of SRG substrate (e.g., on opposing lateral surfaces of the waveguide).

Input couplers 34-1 and 34-2 may be disposed on extension 101 of waveguide 32 or may be located elsewhere on waveguide 32. Diffractive grating structure 100A may couple image light 30 into waveguide 32 and may direct image light 30 towards interleaved coupler 107 (e.g., towards a first spatial region of interleaved coupler 107). Input coupler 34-2 may couple supplemental light 54 into waveguide 32 and may direct supplemental light 54 towards interleaved coupler 107 (e.g., towards a second spatial region of interleaved coupler 107 that is smaller than the first spatial region and that is located between the lateral periphery of the first spatial region and the lateral edges 104 of interleaved coupler 107). Diffractive grating structures 108A and 108B may each diffract both image light 30 and supplemental light 54 out of waveguide 32 and towards the eye box. Diffractive grating structures 108A and 108B may diffract image light 30 only onto angles within central region 46 of eye box FOV 48 (FIG. 2). Diffractive grating structures 108A and 108B may diffract supplemental light 54 only onto a small subset of angles within peripheral region 50 of eye box FOV 48.

Diffractive grating structures 108A and 108B are illustrated in FIG. 6 as planes of constant refractive index when implemented as respective sets of holograms 92 or as lines of constant of constant SRG substrate thickness (e.g., ridges 78 of FIGS. 3A-3C) when implemented as respective SRGs 74. Diffractive grating structure 108A may be characterized by a first set of grating vectors k1. Diffractive grating structure 108B may be characterized by a second set of grating vectors k2. Grating vectors k2 may be oriented at one or more non-parallel angles with respect to grating vectors k1.

The magnitudes of grating vectors k1 correspond to the spacings between (e.g., the period of) the planes of constant refractive index or constant SRG substrate thickness of diffractive grating structure 108A, as well as to the wavelengths of light diffracted by diffractive grating structure 108A. The magnitudes of grating vectors k2 correspond to the spacings between the planes of constant refractive index or constant SRG substrate thickness of diffractive grating structure 108B, as well as to the wavelengths of light diffracted by diffractive grating structure 108B. The magnitude of each grating vector k2 may, if desired, be equal to the magnitude of a respective one of the grating vectors k1 (e.g., diffractive grating structures 108A and 108B may diffract the same wavelengths of light). While illustrated within the plane of the page of FIG. 6 for the sake of clarity, grating vectors k1 and/or k2 may have non-zero vector components parallel to the Y-axis (e.g., grating vectors k1 and k2 may be tilted into or out of the page).

Grating vectors k1 may be oriented in or around a first direction. When implemented using a set of holograms 92, diffractive grating structure 108A may include multiple holograms that are multiplexed or superimposed within the same volume of grating medium 40 (e.g., at each point across the lateral area spanned by interleaved coupler 107), each characterized by a different respective grating vector k1 (e.g., oriented in or around the first direction). Each of the multiplexed holograms may, for example, diffract a different respective incident angle (or range of incident angles) and/or wavelength (or range of wavelengths) of image light 30 and/or supplemental light 54 onto a corresponding output angle (or range of output angles). Similarly, grating vectors k2 may be oriented in or around a second direction different than (e.g., orthogonal to) the first direction. When implemented using a set of holograms 92, diffractive grating structure 108B may include multiple holograms that are multiplexed or superimposed within the same volume of grating medium 40 (e.g., at each point across the lateral area spanned by interleaved coupler 107), each characterized by a different respective grating vector k2 (e.g., oriented in or around the second direction). Each of the multiplexed holograms may, for example, diffract a different respective incident angle (or range of incident angles) and/or wavelength (or range of wavelengths) of image light 30 and/or supplemental light 54 onto a corresponding output angle (or range of output angles).

Diffractive grating structures 108A and 108B may diffract incident image light 30 and supplemental light 54 in two different directions, thereby replicating pupils or beams of the image light and the supplemental light. Diffractive grating structures 108A and 108B may additionally or alternatively expand and/or replicate pupils or beams of the image light and the supplemental light. This creates multiple optical paths for image light 30 and supplemental light 54 within interleaved coupler 107 and allows as large an eye box as possible to be filled with light of uniform intensity.

For example, diffractive grating structure 108A may diffract and optionally expand incident image light 30 and supplemental light 54 in a first direction. Diffractive grating structure 108B may diffract and optionally expand incident image light 30 and supplemental light 54 in a second direction. Diffractive grating structure 108A may diffract and optionally expand the image light and supplemental light that has already been diffracted and expanded by diffractive grating structure 108B out of waveguide 32 and towards the eye box. Similarly, diffractive grating structure 108B may diffract and optionally expand the image light that has already been diffracted and expanded by diffractive grating structure 108A out of waveguide 32 and towards the eye box. Interleaved coupler 107 may, for example, allow for two dimensional light expansion without the use of a separate cross-coupler on waveguide 32.

The placement of input coupler 34-2, the angle with which input coupler 34-2 couples supplemental light 54 into waveguide 32, the configuration of diffractive grating structure 108A, and/or the configuration of diffractive grating structure 108B may be selected to direct the supplemental light 54 coupled out of waveguide 32 by interleaved coupler 107 to eye box 24 only within a portion of the peripheral region 50 of eye box FOV 48 (FIG. 2), thereby forming a visual indication for the user (e.g., for performing a gaze-to-wake operation). Input coupler 34-2 need not be located on extension 101 of waveguide 32 and may, if desired, be located elsewhere such as at location 103. Interleaved coupler 107 may have other shapes (e.g., with any desired number of curved and/or straight lateral edges).

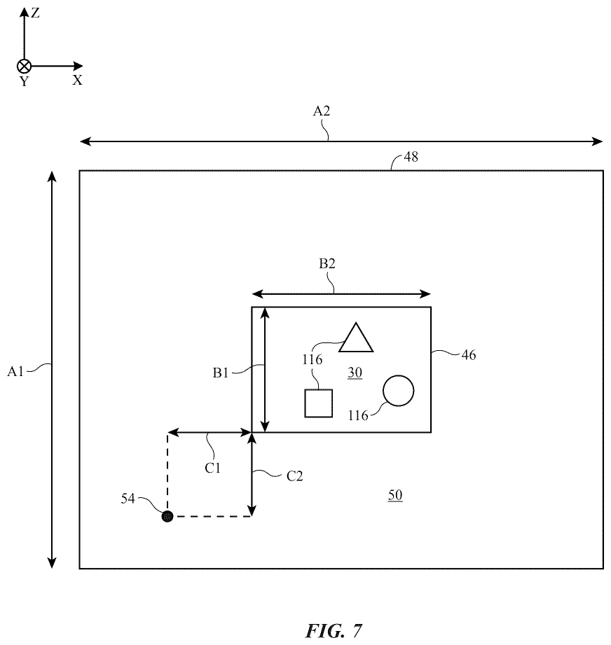

FIG. 7 shows an illustrative eye box FOV 48 as viewed by a user's eye located at eye box 24 of FIG. 2 (e.g., at a fixed nominal distance 44 from waveguide 32). As shown in FIG. 7, eye box FOV 48 may span an angular space having angular dimensions A1-by-A2. At nominal distance 44 (FIG. 2), A1 and A2 may each be equal to 90 degrees, 60-120 degrees, more than 60 degrees, more than 50 degrees, 80-100 degrees, more than 80 degrees, more than 120 degrees, or other values. A1 may correspond to an elevation angle and A2 may correspond to an azimuthal angle, for example. A1 may be equal to A2 or may be different than A2.

Central region 46 may span a subset of eye box FOV 48 at or around a central axis of eye box FOV 48 (e.g., an axis parallel to the Y-axis and extending through the spatial or angular center of eye box FOV 48). For example, central region 46 may span an angular space having angular dimensions B1-by-B2. B1 may be equal to B2 or may be different than B2. B2 may be 22 degrees, 20-25 degrees, 15-30 degrees, 21 degrees, 23 degrees, or other values, as examples. B1 may be 22 degrees, 20-25 degrees, 15-30 degrees, 21 degrees, 23 degrees, 11 degrees, 10-15 degrees, 5-20 degrees, or other values, as examples. Peripheral region 50 may surround central region 46. Peripheral region 50 may, for example, surround and enclose central region 46 in angle space, such that peripheral region 50 extends around the periphery of central region 46 and is angularly located between central region 46 and the periphery of eye box FOV 48.

Output coupler 38 (FIG. 5) or interleaved coupler 107 (FIG. 6) may direct image light 30 towards the eye box within only central region 46 of eye box FOV 48. Image light 30 may contain, include, or represent virtual objects 116 (e.g., graphics, a graphical user interface, text, images, videos, three-dimensional objects or characters, etc.) that are confined to central region 46 (e.g., because image light 30 is not directed to peripheral region 50 of eye box FOV 48). Output coupler 38 may transmit world light from the surroundings (sometimes also referred to herein as external light, scene light, environmental light, or ambient light) to the eye box across all of eye box FOV 48 (e.g., within central region 46 and peripheral region 50). The world light (e.g., light emitted or reflected off real-world external objects) may be overlaid with virtual objects 116 within central region 46 (e.g., in an AR scheme).

Output coupler 38 (FIG. 5) or interleaved coupler 107 (FIG. 6) may direct supplemental light 54 towards the eye box only at a location within peripheral region 50 of eye box FOV 48, shown by graphical indication 110. Put differently, the supplemental light 54 coupled out of the waveguide may be confined to the location of graphical indication 110 (e.g., spanning an angular range of less than 3 degrees, less than 2 degrees, less than 1 degree, etc.). Supplemental light 54 may, for example, be directed to a location within peripheral region 50 of eye box FOV 48 that is offset from the periphery of central region 46 in elevation by angular offset C2 and that is offset from the periphery of central region 46 in azimuth by angular offset C1 (e.g., that is outside of central region 46 by at least angular offsets C1 and C2). In the example of FIG. 7, supplemental light 54 is provided to peripheral region 50 of eye box FOV 48 at a location that is below central region 46 by angular offset C2 and that is to the left of central region 46 by angular offset C1. This is illustrative and non-limiting and, in general, supplemental light 54 may be provided above and to the left of central region 46, above and to the right of central region 46, below and to the right of central region 46, or elsewhere in peripheral region 50.

Angular offsets C1 and C2 may be sufficiently large so as to minimize the risk that the user will accidentally or unintentionally gaze in the direction of graphical indication 110 when the user does not otherwise wish to wake or turn off the projector. Angular offsets C1 and C2 may be, for example, 20 degrees, 15 degrees, 25 degrees, 30 degrees, 15-25 degrees, 18-22 degrees, 19-21 degrees, 10-30 degrees, 5-40 degrees, more than 10 degrees, more than 15 degrees, greater than or equal to 20 degrees, or other values. Angular offset C1 may be equal to angular offset C2 or may be different than angular offset C2. Graphical indication 110 may effectively form a point source of supplemental light 54 (e.g., a virtual light source 52 (FIG. 2) overlaid with peripheral region 50 but transparent to world light) or graphical indicator that serves as a focal or gaze point for the user to view in order to provide a gaze-based user input to display 20. The gaze-based user input may be an instruction to wake or turn off the projector (sometimes referred to herein as a gaze-to-wake operation). Graphical indication 110 is sometimes also referred to herein as gaze-to-wake indicator 110, gaze-to-wake icon 110, or gaze-to-wake indication 110.

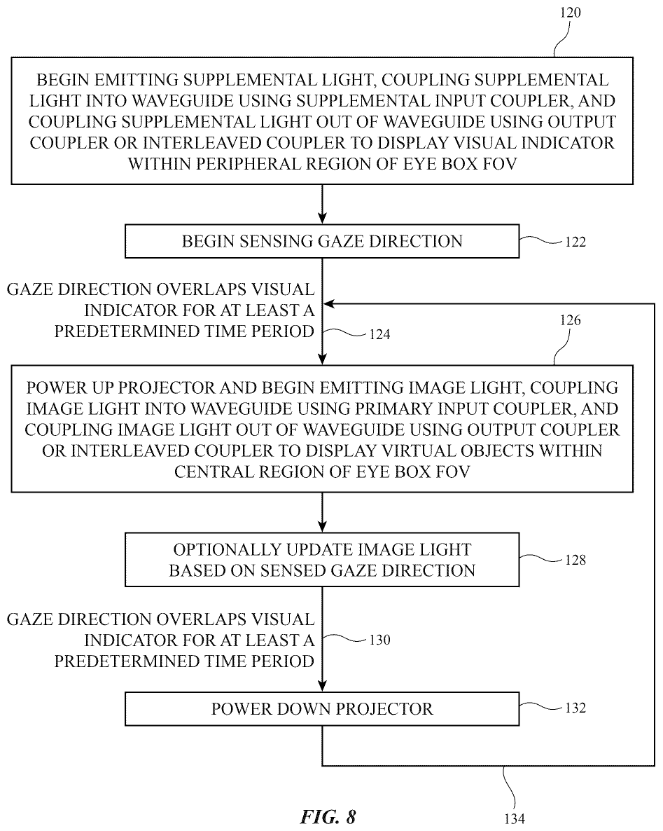

FIG. 8 is a flow chart showing one example of how supplemental light 54 and graphical indication 110 may be used to perform a gaze-to-wake operation in display 20. The operations of FIG. 8 may, for example, be performed after a user has donned system 10 (FIG. 1) on their head, placing their eye at eye box 24.

At operation 120, light source 52 may begin emitting supplemental light 54 while projector 26 does not output image light 30. Projector 26 may be turned off, powered off, powered down, inactive, idle, asleep, or in any other operating state in which projector 26 is not providing image light 30 to waveguide 32. As such, no virtual objects 116 (FIG. 7) are provided to central region 46 of eye box FOV 48.

Input coupler 34-2 (FIGS. 2, 5, and 6) may couple supplemental light 54 into waveguide 32. Waveguide 32 may direct supplemental light 54 to cross-coupler 36 and output coupler 38 (FIG. 5) or to interleaved coupler 107 (FIG. 6). Output coupler 38 (FIG. 5) or interleaved coupler 107 (FIG. 6) may couple supplemental light 54 out of waveguide 32. Diffractive grating structure 100C (FIG. 5) or diffractive grating structures 108A and 108B (FIG. 6) may diffract supplemental light 54 onto diffracted (output) angles that reach eye box FOV 48 at a location (within peripheral region 50) that is angularly separated from central region 46 by angular offsets C1 and C2 (FIG. 7), forming a graphical indication 110 that may be visible to a viewer's eye at the eye box. Waveguide 32 may continue to direct supplemental light 54 to eye box 24 during the remaining operations of FIG. 8. Since light source 52 does not consume much power, waveguide 32 may continue to display supplemental light 54 at eye box 24 without excessive burden on the battery for system 10.

At the same time, a gaze tracking sensor may identify, estimate, detect, and/or track the direction of the user's gaze at the eye box (e.g., using light 4 and reflected light 4R of FIG. 1). This may include, for example, generating, computing, calculating, or identifying gaze tracking sensor data (e.g., a gaze vector) associated with the direction of the user's gaze at the eye box. Control circuitry 16 (FIG. 1) may process and monitor gaze tracking sensor data to determine whether the user is gazing in the direction of graphical indicator 110. If/when the user's gaze direction overlaps graphical indicator 110 (e.g., a location in peripheral region 50 separated from central region 46 of eye box FOV 48 by angular offsets C1 and C2) for at least a predetermined time period, processing may proceed to operation 126 as shown by arrow 124. The predetermined time period may be sufficiently long (e.g., 1-10 seconds or other values) to minimize the risk of the projector changing states when the user inadvertently or incidentally gazes in the direction of graphical indicator 110.

At operation 126 (e.g., responsive to the user gazing in the direction of visual indicator 110 and supplemental light 54 for at least the predetermined time period), control circuitry 16 may power on, power up, activate, turn on, enable, or otherwise adjust projector 26 to begin producing image light 30. Waveguide 32 may direct image light 30 towards central region 46 of eye box FOV 48.

If desired, at optional operation 128, projector 26 may update or adjust image light 30 (e.g., one or more virtual objects 116 within image light 30) based on the user's gaze over time (e.g., as detected using the gaze tracking sensor). If/when the user's gaze direction overlaps graphical indicator 110 (e.g., a location in peripheral region 50 separated from central region 46 of eye box FOV 48 by angular offsets C1 and C2) for at least the predetermined time period, processing may proceed to operation 132 as shown by arrow 130.

At operation 132 (e.g., responsive to the user gazing in the direction of visual indicator 110 and supplemental light 54 for at least the predetermined time period), control circuitry 16 may power off, power down, deactivate, turn off, disable, or otherwise adjust projector 26 to stop producing image light 30. The predetermined time period and sufficiently high angular offsets C1 and C2 may prevent the user from inadvertently or incidentally turning off projector 26 while viewing virtual objects 116 within central region 46 of eye box FOV 48. Processing may then loop back to arrow 124. This type of gaze-to-wake scheme may allow the user to conserve power on system 10 and to selectively turn the display of image light 30 on or off as needed using only their gaze and without requiring use of their hands or other user input devices, for example.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

System 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, μLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The foregoing is merely illustrative and various modifications can be made to the described embodiments. The foregoing embodiments may be implemented individually or in any combination.

What is claimed is:

1. An electronic device comprising:
a projector configured to output first light containing images;
a light source configured to output second light at a visible wavelength;
a waveguide configured to propagate the first and second light; and
a diffractive grating structure on the waveguide, the diffractive grating structure being configured to
diffract the first light out of the waveguide within a first region of a field of view (FOV), and
diffract the second light out of the waveguide within a second region of the FOV that surrounds the first region.

2. The electronic device of claim 1, wherein the diffractive grating structure comprises a set of volume holograms.

3. The electronic device of claim 1, wherein the diffractive grating structure comprises a surface relief grating.

4. The electronic device of claim 1, wherein the light source comprises a laser.

5. The electronic device of claim 1, wherein the light source comprises a light-emitting diode.

6. The electronic device of claim 1, wherein the light source is external to the projector.

7. The electronic device of claim 1, further comprising:
a first input coupler on the waveguide and configured to couple the first light into the waveguide; and
a second input coupler on the waveguide and configured to couple the second light into the waveguide, the second input coupler being laterally offset from the first input coupler.

8. The electronic device of claim 7, further comprising:
an additional diffractive grating structure on the waveguide, the additional diffractive grating structure being configured to diffract the first light from the first input coupler towards the diffractive grating structure and being configured to diffract the second light from the second input coupler towards the diffractive grating structure.

9. The electronic device of claim 8, wherein the first input coupler comprises a first surface relief grating (SRG), the diffractive grating structure comprises a second SRG, and the additional diffractive grating structure comprises a third SRG.

10. The electronic device of claim 9, wherein the second input coupler comprises an input coupling prism mounted to the waveguide.

11. The electronic device of claim 9, wherein the second input coupler comprises a fourth SRG.

12. The electronic device of claim 11, wherein the waveguide comprises a substrate, the first SRG is formed in a first region of the substrate, the second SRG is formed in a second region of the substrate, the third SRG is formed in a third region of the substrate, and the fourth SRG is formed in a fourth region of the substrate.

13. The electronic device of claim 8, wherein the waveguide comprises a layer of grating medium, the diffractive grating structure comprises a first set of holograms in a first region of the layer of grating medium, and the additional diffractive grating structure comprises a second set of holograms in a second region of the layer of grating medium.

14. The electronic device of claim 7, wherein the diffractive grating structure has a first grating vector and the electronic device further comprises:
an additional diffractive grating structure overlapping the diffractive grating structure and having a second grating vector oriented at a non-parallel angle with respect to the first grating vector, the additional diffractive grating structure being configured to diffract the first light out of the waveguide within the first region of the FOV and being configured to diffract the second light out of the waveguide within the second region of the FOV; and
an interleaved coupler on the waveguide and including the diffractive grating structure and the additional diffractive grating structure.

15. The electronic device of claim 1, wherein the diffractive grating structure is further configured to confine the second light to a location within the second region of the FOV, the location being at least 10 degrees from an edge of the first region of the FOV.

16. The electronic device of claim 1, further comprising:
a gaze tracking sensor configured to estimate a gaze direction within the FOV; and
one or more processors configured to wake the projector responsive to the estimated gaze direction overlapping the location for at least a predetermined time period.

17. An electronic device configured to display images at an eye box having a field of view (FOV), the electronic device comprising:
a projector configured to generate first light containing the images;
a light source configured to generate second light at a visible wavelength;
a waveguide;
a first input coupler configured to couple the first light into the waveguide;
a second input coupler configured to couple the second light into the waveguide; and
a diffractive grating structure configured to couple the first and second light out of the waveguide, the first light being confined to a central region of the FOV and the second light being confined to a location within the FOV that is at least 10 degrees outside of the central region.

18. The electronic device of claim 17, further comprising:
a gaze tracking sensor configured to estimate a gaze direction at the eye box; and
one or more processors configured to adjust the projector responsive to the estimated gaze direction overlapping the location for at least a predetermined time period.

19. A method of operating an electronic device, comprising:
coupling, using a first input coupler, first light containing images into a waveguide;
coupling, using a second input coupler, second light at a visible wavelength into the waveguide;
coupling, using a diffractive grating structure, the first light out of the waveguide and confined to a region of a field of view (FOV) of an eye box; and
coupling, using the diffractive grating structure, the second light out of the waveguide at a location within the FOV that outside the region of the FOV and that is separated from an edge of the region of the FOV by at least 10 degrees.

20. The method of claim 19, further comprising:
estimating, using an infrared emitter and an infrared sensor, a gaze direction at the eye box; and
controlling, using one or more processors, a projector to begin producing the first light responsive to the gaze direction overlapping the location for at least a predetermined time period.
